(19) United States
(12) Patent Application Publication
(10) Pub. No.: US 2014/0306990 A1
(43) Pub. Date: Oct. 16, 2014

(54) INFORMATION PROCESSING APPARATUS, INFORMATION PROCESSING METHOD AND INFORMATION PROCESSING SYSTEM

(71) Applicant: Akiyoshi NAKAI, Kanagawa (JP)

(72) Inventor: Akiyoshi NAKAI, Kanagawa (JP)

(21) Appl. No.: 14/251,756

(22) Filed: Apr. 14, 2014

(30) Foreign Application Priority Data
Apr. 16, 2013 (JP) 2013-085434
Mar. 6, 2014 (JP) 2014-043912

(51) Int. Cl. G09G 5/00; G06T 11/60

(52) U.S. Cl. CPC G09G 5/005; G06T 11/60
USPC 345/629; 345/522

(57) ABSTRACT

An information processing apparatus includes a reception unit that receives image data; a determination unit that determines output image data based on a presence or absence of a specified signal added to the image data; and an output unit that outputs the output image data.

### BACKGROUND OF THE INVENTION

1. Field of the Invention

The disclosures herein generally relate to an information processing apparatus, an information processing method and an information processing system.

2. Description of the Related Art

For example, while a presentation is given displaying an image on a screen using a projector or the like, when a presentation document is changed or the like, a desktop screen on a PC (personal computer) or an accidentally opened document may be displayed on the screen. If an important secret document is included in the desktop screen or in the accidentally opened document, the important secret document will be leaked to participants of the presentation.

In order to prevent the unintended leak of information as described above, Japanese Patent No. 3707407, for example, discloses a projector which issues a password. When the password is input from a PC connected to the projector, the projector starts communication with the PC and projection of an image sent from the PC.

However, the projector disclosed in the Japanese Patent No. 3707407 requires input of the password every time a presentation starts. This may impose a burden on the user, and may hinder the smooth progress of the presentation.

### SUMMARY OF THE INVENTION

It is a general object of at least one embodiment of the present invention to provide an information processing apparatus, an information processing method and an information processing system that substantially obviates one or more problems caused by the limitations and disadvantages of the related art.

In one embodiment, an information processing apparatus includes a reception unit that receives image data; a determination unit that determines output image data based on a presence or absence of a specified signal added to the image data; and an output unit that outputs the output image data.

In another embodiment, an information processing method includes receiving image data; determining output image data based on a presence or absence of a specified signal added to the image data; and outputting the output image data.

In yet another embodiment, an information processing system includes an input device and an information processing apparatus, which are connected to each other. The input device includes a specified signal addition unit that adds a specified signal to image data. The information processing apparatus includes a reception unit that receives the image data from the input device; a determination unit that determines output image data based on a presence or absence of the specified signal added to the image data; and an output unit that outputs the output image data.

According to the embodiment of the present invention, an information processing apparatus that prevents an accidental output of image data is provided.

### BRIEF DESCRIPTION OF THE DRAWINGS

Other objects and further features of embodiments will be apparent from the following detailed description when read in conjunction with the accompanying drawings, in which:

FIG. 1 is a diagram illustrating an example of an entire configuration of an information processing system according to a first embodiment;

FIG. 2 is a diagram illustrating an example of a hardware configuration of a terminal according to the first embodiment;

FIG. 3 is a diagram illustrating an example of a hardware configuration of an information processing apparatus according to the first embodiment;

FIG. 4 is a diagram illustrating an example of a projector according to the first embodiment;

FIG. 5 is a diagram illustrating an example of a functional configuration of the information processing system according to the first embodiment;

FIG. 6 is a flowchart illustrating an example of a process of adding a specified signal according to the first embodiment;

FIG. 7 is a flowchart illustrating an example of a first process of outputting image data according to the first embodiment;

FIGS. 8A and 8B are diagrams illustrating examples of an image displayed by the first process of outputting image data according to the first embodiment;

FIG. 9 is a flowchart illustrating an example of a second process of outputting image data according to the first embodiment;

FIGS. 10A and 10B are diagrams illustrating examples of an image displayed by the second process of outputting image data according to the first embodiment;

FIG. 11 is a flowchart illustrating an example of a third process of outputting image data according to the first embodiment;

FIGS. 12A to 12C are diagrams illustrating examples of an image displayed by the third process of outputting image data according to the first embodiment;

FIG. 13 is a flowchart illustrating an example of a fourth process of outputting image data according to the first embodiment;

FIGS. 14A and 14B are diagrams illustrating examples of an image displayed by the fourth process of outputting image data according to the first embodiment;

FIG. 15 is a flowchart illustrating an example of a fifth process of outputting image data according to the first embodiment;

FIGS. 16A to 16C are diagrams illustrating examples of an image displayed by the fifth process of outputting image data according to the first embodiment;

FIG. 17 is a diagram illustrating an example of an entire configuration of an information processing system according to a second embodiment; and

FIG. 18 is a diagram illustrating an example of a functional configuration of the information processing system according to the second embodiment.

### DESCRIPTION OF THE PREFERRED EMBODIMENTS

In the following, embodiments of the present invention will be described with reference to the accompanying drawings. In each drawing, to the same element or parts, the same reference numeral is assigned and duplicate explanation may be omitted.

### First Embodiment

### Whole Configuration

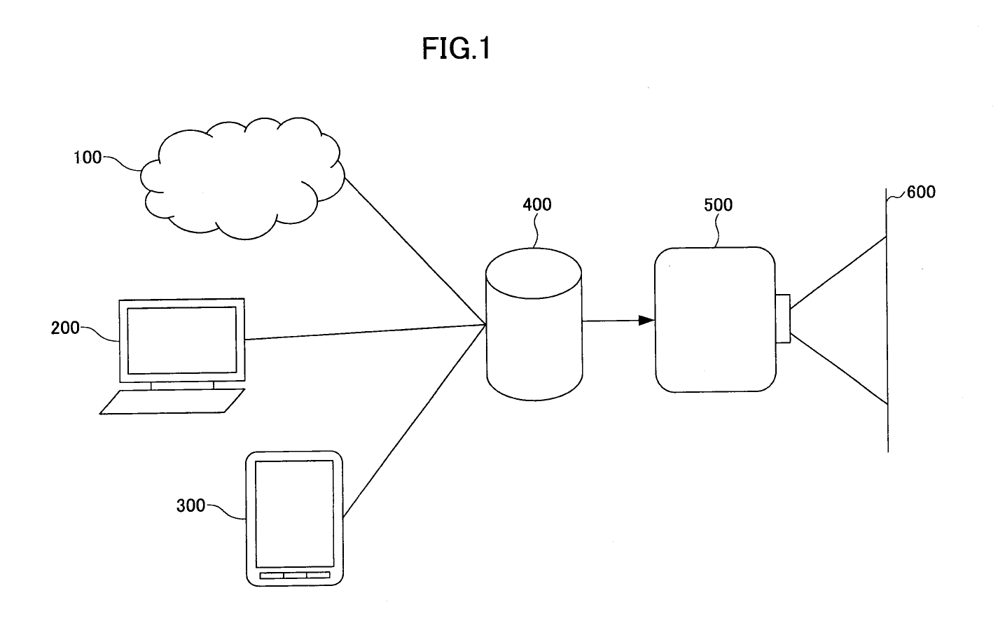

FIG. 1 is a diagram illustrating an example of the entire configuration of an information processing system according to the first embodiment.

In the configuration illustrated in FIG. 1, image data are sent from a cloud 100, a PC (personal computer) terminal 200 or a tablet type terminal 300 to an information processing apparatus 400, and image data output after a process at the image processing apparatus 400 are displayed on a screen 600 by a projector 500.

The cloud 100, the PC terminal 200 or the tablet type terminal 300 is an example of an input device, which sends image data to image processing apparatus 400. Meanwhile, the input device will work as long as it can send image data, and is not limited to them. Moreover, the number of input devices connected to the information processing apparatus 400 may be one or more.

The projector 500 is an example of an image display device, and projects image data output from the information processing apparatus 400 onto the screen 600. Meanwhile, the image display device is not limited to the projector 500, but may be, for example, a liquid crystal display, an organic EL (electro-luminescence) display or the like.

Meanwhile, respective connections of the cloud 100, the PC terminal 200 and the tablet type terminal 300 to the information processing apparatus 400 may be wired connections or wireless connections. The wired connections and the wireless connections may be mixed. Moreover, the information processing apparatus 400 and the projector 500 may be connected by wire or wirelessly.

### Hardware Configuration

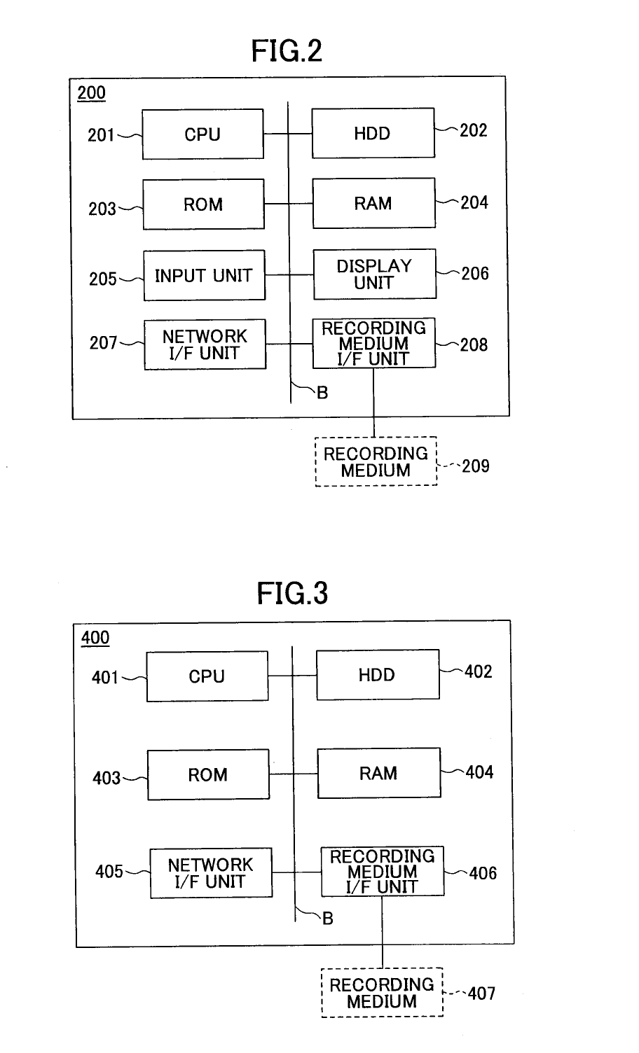

FIG. 2 is a diagram illustrating an example of a hardware configuration of the PC terminal 200 as the example of the input device according to the present embodiment.

As shown in FIG. 2, the PC terminal 200 includes a CPU 201, a HDD 202, a ROM 203, a RAM 204, an input unit 205, a display unit 206, a network I/F unit 207, and a recording medium I/F unit 208. These units are connected to each other via a bus B.

The ROM 203 stores various kinds of programs, data used by the programs and the like. The RAM 204 is used as a storage area for a loaded program, a work area for the loaded program or the like. The CPU 201 realizes various kinds of functions by processing the program loaded in the RAM 204. The HDD 202 stores programs, various kinds of data used by the program or the like.

The input unit 205 includes, for example, a keyboard, a mouse or the like. The display unit 206 includes, for example, a display screen or the like, and displays data held in the PC terminal 200 or the like.

The network I/F unit 207 is hardware for connecting to a network such as a LAN (local area network). The network may be wireless or wired. The recording medium I/F unit 208 is an interface to a recording medium. The PC terminal 200 can read out from and/or write to a recording medium 209 via the recording medium I/F unit 208. The recording medium 209 may be a flexible disk, a CD (compact disk), a DVD (Digital versatile disk), a SD (Secure Digital) memory card, a USB (Universal Serial Bus) memory or the like.

Meanwhile, a server terminal included in the cloud 100 or the tablet type terminal 300 has a configuration similar to that of the PC terminal 200, and includes functions which will be explained below.

FIG. 3 is a diagram illustrating an example of a hardware configuration of the information processing apparatus 400 according to the present embodiment.

As shown in FIG. 3, the information processing apparatus 400 includes a CPU 401, a HDD 402, a ROM 403, a RAM 404, a network I/F unit 405 and a recording medium I/F unit 406. These units are connected to each other via a bus B.

The ROM 403 stores various kinds of programs, data used by the programs and the like. The RAM 404 is used as a storage area for a loaded program, a work area for the loaded program or the like. The CPU 401 realizes various kinds of functions by processing the program loaded in the RAM 404. The HDD 402 stores programs, various kinds of data used by the program or the like.

The network I/F unit 405 is hardware for connecting to a network such as a LAN. The network may be wireless or wired. The recording medium I/F unit 406 is an interface to a recording medium. The information processing apparatus 400 can read out from and/or write to a recording medium 407 via the recording medium I/F unit 406. The recording medium 407 may be a flexible disk, a CD, a DVD, a SD memory card, a USB memory or the like.

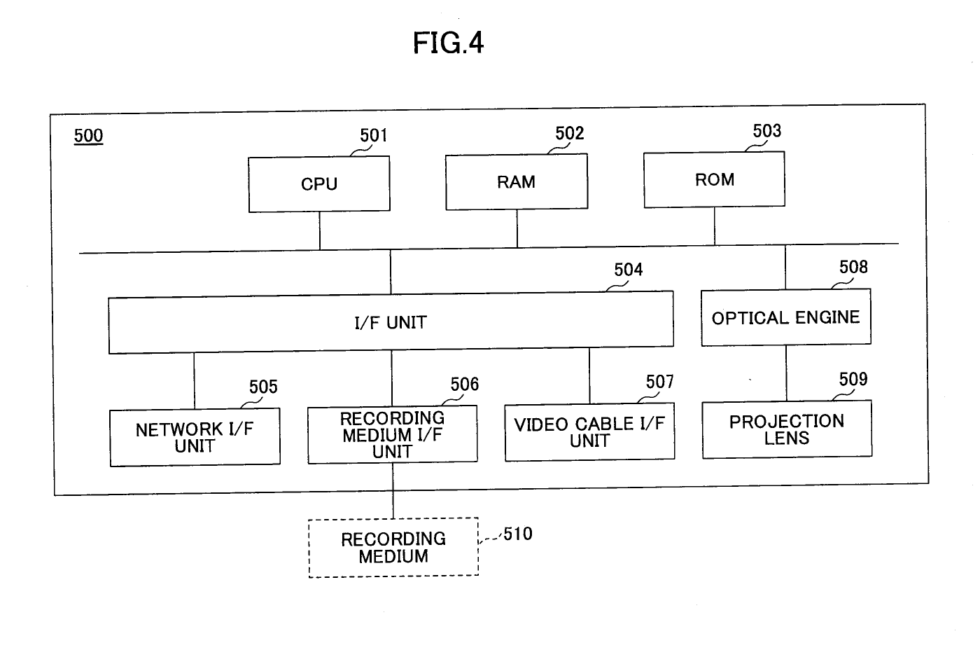

FIG. 4 is a diagram illustrating an example of a hardware configuration of the projector 500 according to the present embodiment.

As shown in FIG. 4, the projector 500 includes a CPU 501, a RAM 502, a ROM 503, an I/F unit 504, a network I/F unit 505, a recording medium I/F unit 506 a video cable I/F unit 507, an optical engine 508 and a projection lens 509.

The ROM 503 stores various kinds of programs, data used by the programs and the like. The RAM 502 is used as a storage area for a loaded program, a work area for the loaded program or the like. The CPU 501 realizes various kinds of functions by processing the program loaded in the RAM 502.

The I/F unit 504 is a peripheral bus, a DMAC (Direct Memory Access Controller), a bus controller or the like, which adjusts priorities of data received by the network I/F unit 505, the recording medium I/F unit 506 and the video cable I/F unit 507, and stores the data in the RAM 502. Moreover, the I/F unit 504 inputs/outputs data among the network I/F unit 505, the recoding medium I/F unit 506 and the video cable I/F unit 507.

The network I/F unit 505 is hardware for connecting to a network such as a LAN. The network may be wireless or wired. The recording medium I/F unit 506 is an interface to a recording medium. The projector 500 can read out from and/or write to a recording medium 510 via the recording medium I/F unit 506. The recording medium 510 may be a flexible disk, a CD, a DVD, a SD memory card, a USB memory or the like. The video cable I/F unit 507 is an interface for acquiring a video signal from a video cable (for analogue data or digital data). The projector 500 can acquire a video signal from an external device via the video cable I/F unit 507 and project the video signal.

The optical engine 508 projects a video, for example, by the DLP (Digital Light Processing) method which uses a micro mirror. Meanwhile, the projection method of video is not limited to the DLP method, but other projection method, such as the 3LCD method which uses a transparent-type liquid-crystal, or the LCOS (liquid crystal on silicon) method which uses a reflection-type liquid-crystal, for example, may be used. The projection lens 509 is configured including, for example, a fixed focus lens, which has a focal length, brightness, an angle of view or the like determined according to a condition of use of the projector 500, and a zoom lens or the like.

### Functional Configuration

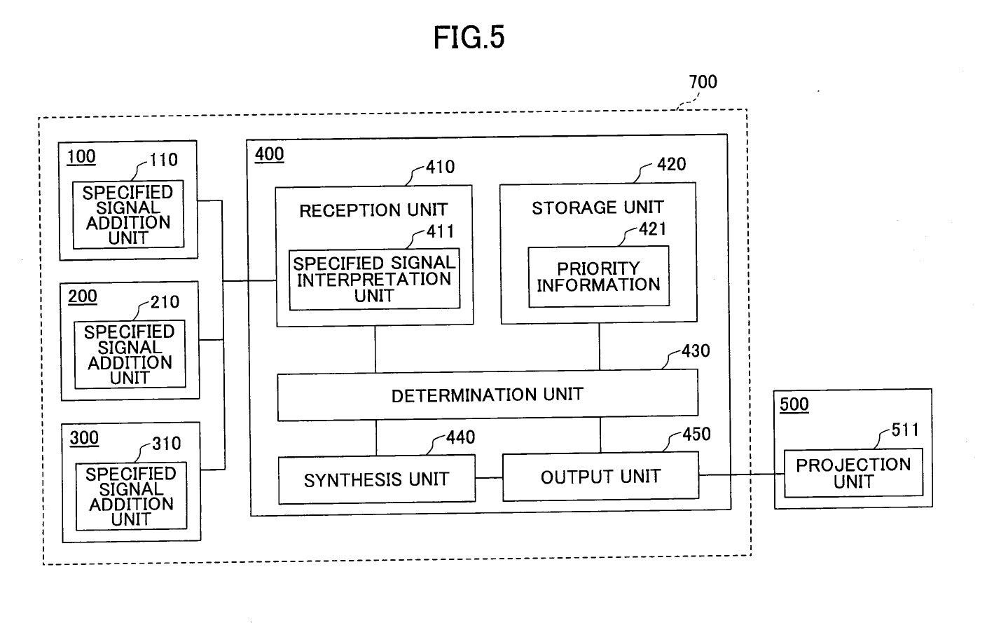

FIG. 5 is a diagram illustrating an example of a functional configuration according to the present embodiment.

As shown in FIG. 5, the cloud 100, the PC terminal 200 and the tablet type terminal 300 have specified signal addition units 110, 210 and 310, respectively. Each of the specified signal addition units 110, 210 and 310 adds a specified signal, which is a flag signal for example, to image data to be displayed by the projector 500, and sends the image data to the information processing apparatus 400. Each of the specified signal addition unit 110, 210 and 310 may add the specified signal at the same time as a transmission of the image data starts, or the addition of the specified signal may start or end during the transmission of the image data.

The information processing apparatus 400 includes a reception unit 410, a storage unit 420, a determination unit 430, a synthesis unit 440 and an output unit 450. An information processing system 700 includes the information processing apparatus 400 and input devices including the cloud 100, the PC terminal 200 and the tablet type terminal 300.

The reception unit 410 receives image data sent from the cloud 100, the PC terminal 200 or the tablet type terminal 300. A specified signal interpretation unit 411 included in the reception unit 410 determines whether a specified signal is added to the received image data.

The storage unit 420 stores priority information 421, which is preliminarily set, of image data or the like. The priority information 421 is information which is a criterion for determining image data to be output to the projector 500 by the determination unit 430 in the case where image data of plural images, to which specified signals are added, are received, for example. The priority is preliminarily set, for example, for devices connected to the information processing apparatus 400 (in the present embodiment, the cloud 100, the PC terminal 200 and the tablet type terminal 300) or a kind of application, software or the like.

The determination unit 430 determines, in the case where the reception unit 410 receives image data, image data to be output to the projector 500 based on whether a specified signal is added or the priority information 421. A method of determining the image data to be output by the determination unit 430 will be described later. In the case of determining by the determination unit 430 that image data of plural images are combined and output, the synthesis unit 440 combines the received image data of plural images. The determination unit 430 and the synthesis unit 440 are functions realized by a cooperation of, for example, a program stored in the ROM 403 and the hardware such as the CPU 401, the RAM 404 or the like.

The output unit 450 outputs the image data determined to be output by the determination unit 430 or the image data synthesized by the synthesis unit 440 to the projector 500.

The projector 500 includes a projection unit 511 having the optical engine 508, the projection lens 509 and the like. The projection unit 511 displays the image data output from the information processing apparatus 400 by projecting an image of the image data onto the screen 600.

### Specified Signal Addition Process

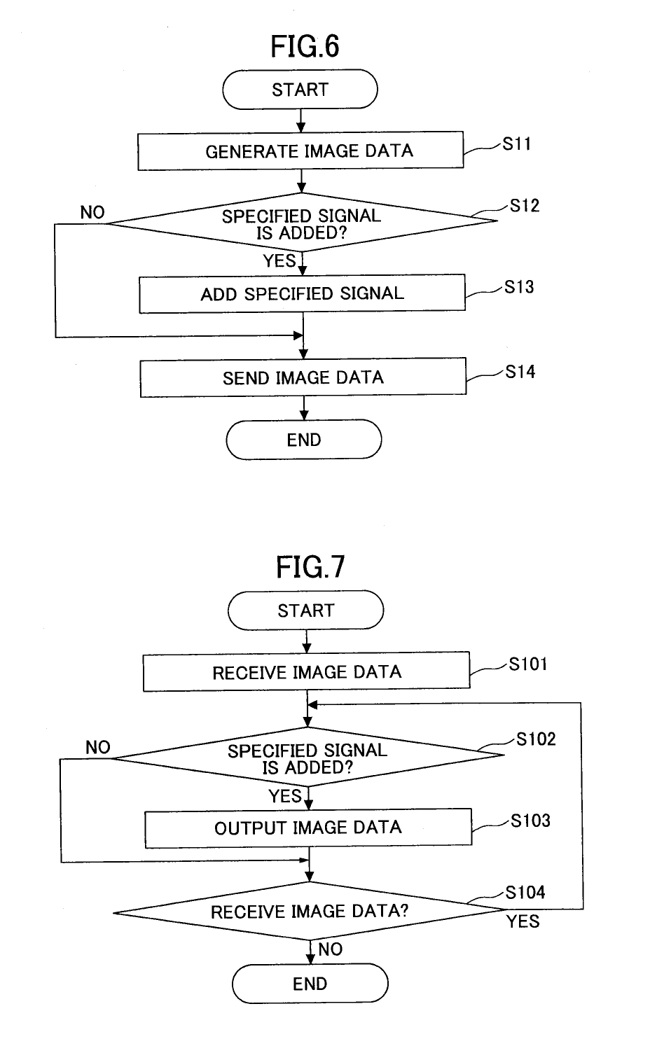

FIG. 6 is a flowchart illustrating an example of the process of adding a specified signal according to the present embodiment. The cloud 100, the PC terminal 200 and the tablet type terminal 300 send image data to the information processing apparatus 400 after executing the specified signal addition process which will be explained as follows.

In the case where the cloud 100, the PC terminal 200 or the tablet type terminal 300 sends image data to the projector 500, the image data to be sent are generated at first (step S11). Next, it is determined whether a specified signal is added to the image data (step S12). In the case of adding the specified signal, the specified signal is added to the image data (step S13). Next, the image data to which the specified signal is added or the image data to which the specified signal is not added are sent to the image processing apparatus 400 (step S14).

The specified signal addition process is continuously executed in the case of sending image data to the projector 500. The addition of the specified signal may be executed at the same time as a transmission of the image data starts, or the addition of the specified signal may start or end during the transmission of the image data.

### Image Data Output Process

Next, a process of outputting image data in the information processing apparatus 400 will be explained. When the information processing apparatus 400 receives image data from the input device such as the cloud 100, the PC terminal 200, the tablet type terminal 300 or the like, the information processing apparatus 400 executes any one of the image data output processes, which will be explained as follows, and outputs the image data to the projector 500.

### First Image Data Output Process

FIG. 7 is a flowchart illustrating an example of a first process of outputting image data according to the present embodiment. The first image data output process is a process in the case where the image data are sent to the image processing apparatus 400 from any one of the cloud 100, the PC terminal 200 and the tablet type terminal 300.

When the image data are sent to the information processing apparatus 400, the reception unit 410 receives the image data (step S101). Next, the specified signal interpretation unit 411 determines whether a specified signal is added (step S102). In the case where a specified signal is added to the image data (step S102: YES), the determination unit 430 determines the received image data to be output, and the output unit 450 outputs the image data to the projector 500 (step S103).

Next, in the case where the reception unit 410 continues receiving image data (step S104: YES), the process from step S102 is executed again. In the case that the transmission of image data from the cloud 100, the PC terminal 200 or the tablet type terminal 300 has stopped and the reception unit 410 does not receive image data (step S104: NO), the first image data output process ends.

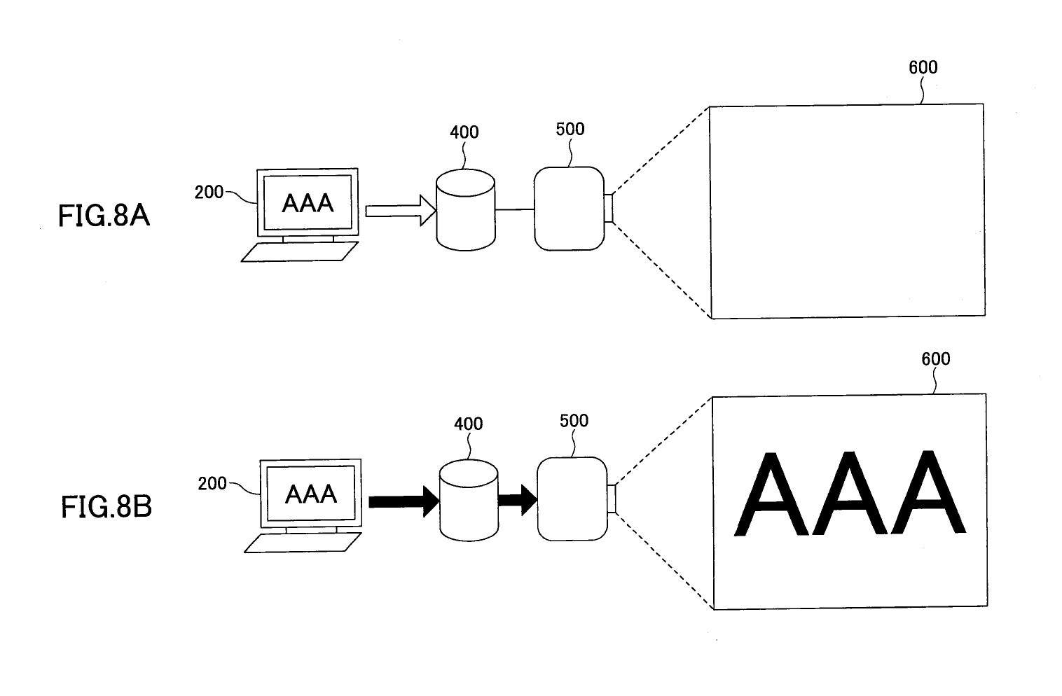

As described above, according to the first image data output process, in the case where image data, to which a specified signal is not added, are sent from the PC terminal 200 to the information processing apparatus 400, the image data are not output from the information processing apparatus 400 to the projector 500. Accordingly, in this case, as shown in FIG. 8A, the image displayed on the PC terminal 200 is not projected onto the screen 600.

Moreover, in the case that image data, to which a specified signal is added, are sent from, for example, the PC terminal 200 to the information processing apparatus 400, the image data are output from the information processing apparatus 400 to the projector 500. Accordingly, in this case, as shown in FIG. 8B, the image displayed on the PC terminal 200 is projected onto the screen 600.

### Second Image Data Output Process

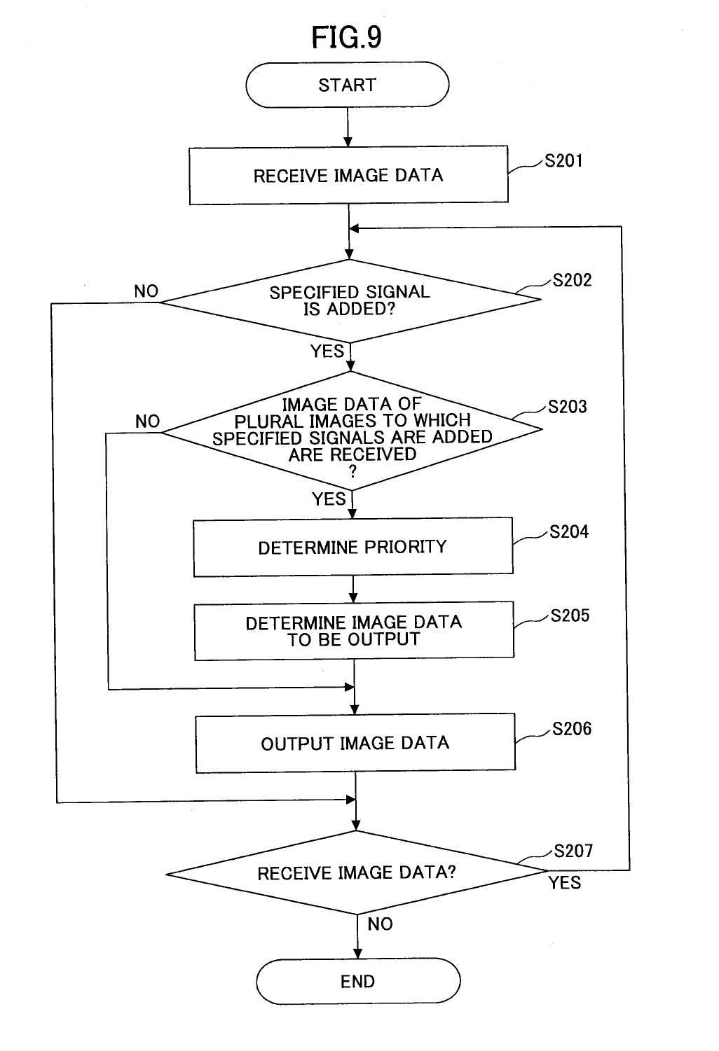

FIG. 9 is a flowchart illustrating an example of a second process of outputting image data according to the present embodiment. In the second image data output process, in the case where the image data are sent to the image processing apparatus 400 from plural devices out of the cloud 100, the PC terminal 200 and the tablet type terminal 300, image data are output in order of priority which is preliminarily determined.

When image data are sent to the information processing apparatus 400, the reception unit 410 receives the image data (step S201). Next, the specified signal interpretation unit 411 determines whether a specified signal is added to the image data (step S202). Moreover, the specified signal interpretation unit 411 acquires a number of images of the image data to which specified signals are added (step S203).

In the case where the reception unit 410 receives image data of plural images to which specified signals are added (step S203: YES), the determination unit 430 acquires the priority information 421 from the storage unit 420, and determines the priority (step S204). The priority is preliminarily set, for example, for the cloud 100, the PC terminal 200 and the tablet type terminal 300 which are connected to the information processing apparatus 400, and is stored in the storage unit 420 as the priority information 421.

The determination unit 430 determines image data to be output to the projector 500 based on the acquired priority information 421. For example, when image data are sent from the PC terminal 200 and the tablet type terminal 300 to the information processing apparatus 400, and a priority of the PC terminal 200 is higher than that of the tablet type terminal 300, the determination unit 430 determines the data from the PC terminal 200 to be output to the projector 500.

Meanwhile, when the number of images of image data to which a specified signal is added is one (step S203: NO), the determination unit 430 determines the image data to which the specified signal is added to be output to the projector 500.

Next, the output unit 450 outputs the image data determined to be output to the projector 500 by the determination unit 430 to the projector 500 (step S206). Next, in the case where the reception unit 410 continues receiving image data (step S207: YES), the process from step S202 is executed again. In the case that the transmission of image data from the cloud 100, the PC terminal 200 or the tablet type terminal 300 has stopped and the reception unit 410 does not receive image data (step S207: NO), the second image data output process ends.

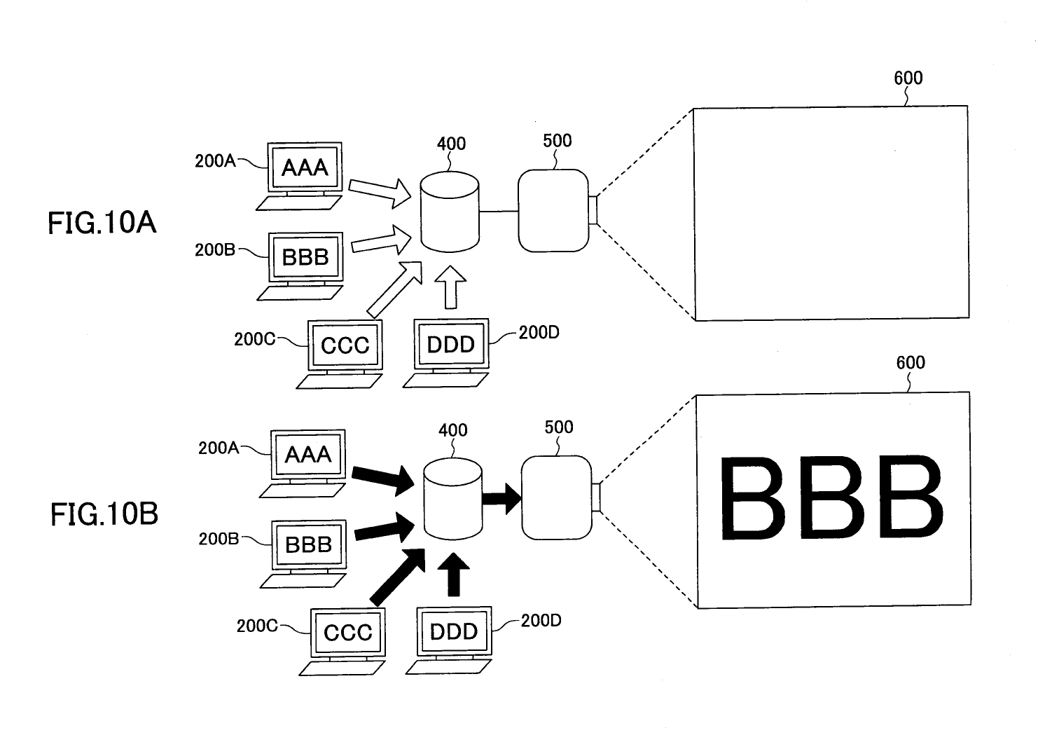

FIGS. 10A and 10B are diagrams illustrating examples of the image displayed by the second image data output process. In the examples shown in FIGS. 10A and 10B, PC terminals 200A to 200D are connected to the information processing apparatus 400, and from the respective PC terminals 200A to 200D, image data are sent to the information processing apparatus 400.

When a specified signal is not added to the image data sent to the information processing apparatus 400 from the PC terminals 200A to 200D, the image data are not output from the information processing apparatus 400 to the projector 500. Accordingly, in this case, as shown in FIG. 10A, the images displayed on the PC terminals 200A to 200D are not projected onto the screen 600.

In the case where specified signals are added to the image data sent from the PC terminals 200A to 200D to the information processing apparatus 400, the determination unit 430 determines the priority. That is, the image data output from the device, the priority of which is the highest, are output to the projector 500. In the example shown in

FIG. 10B, the priority of the PC terminal 200B is the highest among those of the PC terminals 200A to 200D, and the image displayed on the PC terminal 200B is projected onto the screen 600 by the projector 500.

### Third Image Data Output Process

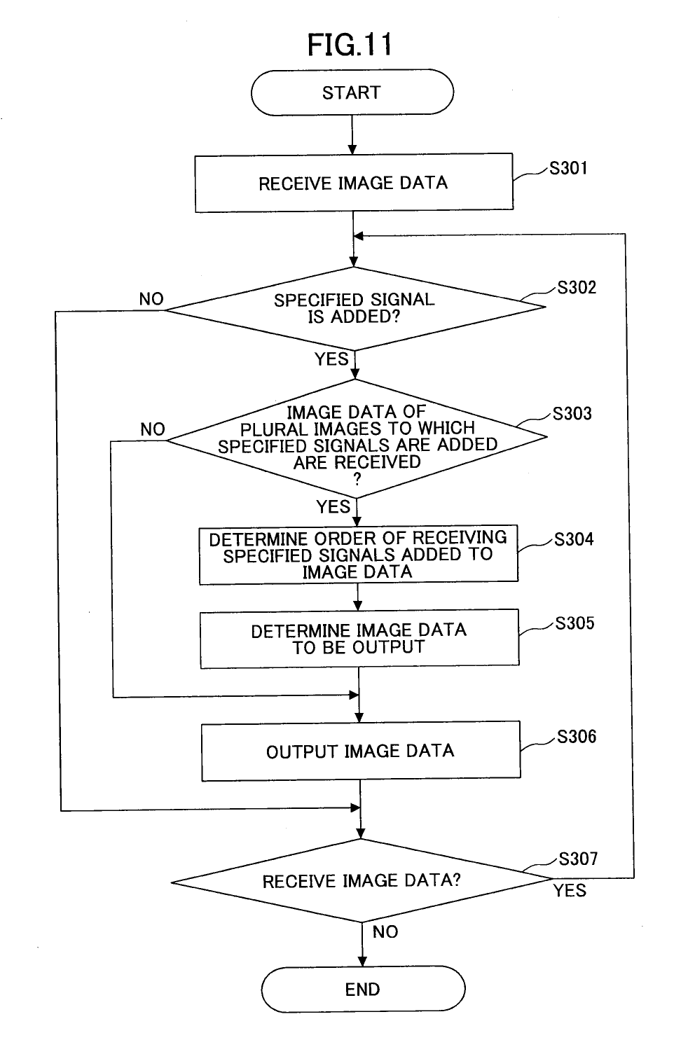

FIG. 11 is a flowchart illustrating an example of a third process of outputting image data according to the present embodiment. In the third image data output process, in the case where the image data are sent to the image processing apparatus 400 from plural devices out of the cloud 100, the PC terminal 200 and the tablet type terminal 300, image data to be output are determined based on an order of receiving specified signals. When image data are sent to the information processing apparatus 400, the reception unit 410 receives the image data (step S301). Next, the specified signal interpretation unit 411 determines whether a specified signal is added to the image data (step S302). Moreover, the specified signal interpretation unit 411 acquires a number of images of the image data to which specified signals are added (step S303).

In the case where the reception unit 410 receives image data of plural images to which specified signals are added (step S303: YES), the determination unit 430 determines an order of receiving the specified signals added to the image data (step S304). Next, the determination unit 430 determines the image data which finally receives the specified signal to be output to the projector 500.

For example, assume that after image data to which a specified signal is added are sent to the information processing apparatus 400 from the PC terminal 200, image data to which a specified signal is added are sent to the information processing apparatus 400 from the tablet type terminal 300. In this case, the determination unit 430 determines the image data sent from the PC terminal 200 to be output until the image data are sent from the tablet type terminal 300. Moreover, the determination unit 430 determines the image data sent from the tablet type terminal 300 to be output after the image data are sent from the tablet type terminal 300.

Meanwhile, when the number of images of the image data to which a specified signal is added is one (step S303: NO), the determination unit 430 determines the image data to which the specified signal is added to be output to the projector 500.

Next, the output unit 450 outputs the image data determined to be output to the projector 500 by the determination unit 430 to the projector 500 (step S306). Next, in the case where the reception unit 410 continues receiving image data (step S307: YES), the process from step S302 is executed again. In the case that the transmission of image data from the cloud 100, the PC terminal 200 or the tablet type terminal 300 has stopped and the reception unit 410 does not receive image data (step S307: NO), the third image data output process ends.

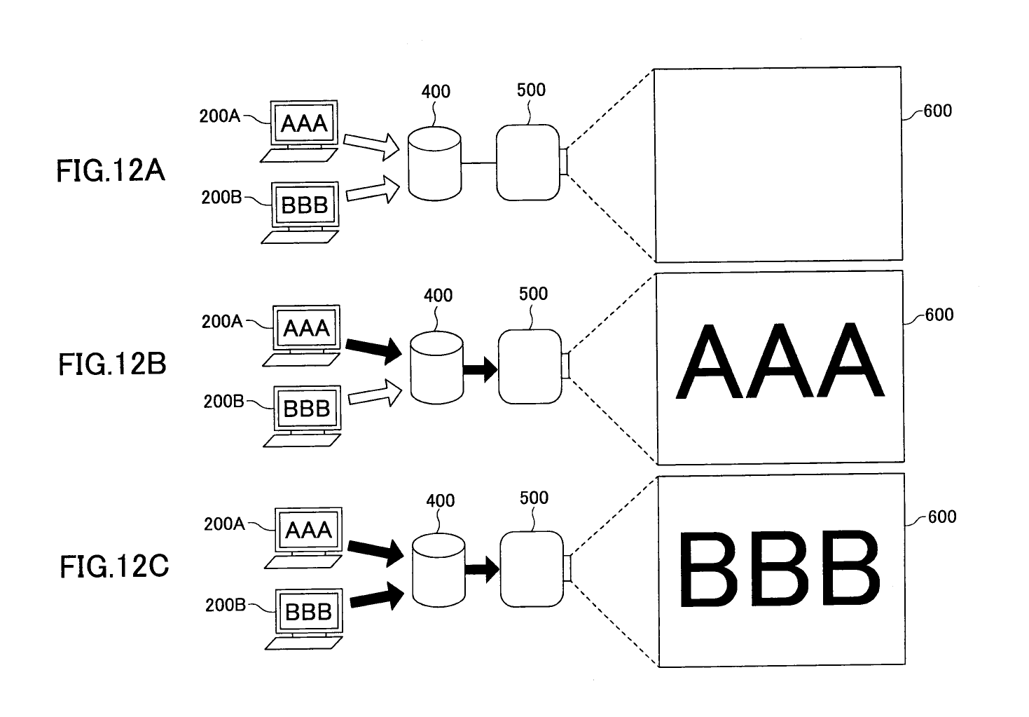

FIGS. 12A to 12C are diagrams illustrating examples of the image displayed by the third image data output process. In the examples shown in FIGS. 12A to 12C, PC terminals 200A and 200B are connected to the information processing apparatus 400, and from the respective PC terminals 200A and 200B, image data are sent to the information processing apparatus 400.

When a specified signal is not added to the image data sent to the information processing apparatus 400 from the PC terminals 200A and 200B, the image data are not output from the information processing apparatus 400 to the projector 500. Accordingly, in this case, as shown in FIG. 12A, the images displayed on the PC terminals 200A and 200B are not projected onto the screen 600.

In the case where a specified signal is added to the image data sent from the PC terminal 200A out of the image data sent from the PC terminals 200A and 200B, the information processing apparatus 400 outputs the image data sent from the PC terminal 200A to the projector 500. Accordingly, in this case, as shown in FIG. 12B, the image displayed on the PC terminal 200A is projected onto the screen 600 by the projector 500.

Moreover, in the case where from the state shown in FIG. 12B a specified signal is added to the image data sent from the PC terminal 200B, the information processing apparatus 400 outputs the image data from the PC terminal 200B, which receives the specified signal later, to the projector 500. Accordingly, in this case, as shown in FIG. 12C, the image displayed on the PC terminal 200B is projected onto the screen 600 by the projector 500.

Meanwhile, in the present embodiment, the example where image data to which a specified signal is added later are output to the projector 500 is explained as above. However, the information processing apparatus 400 may be set so as to continue outputting image data to which a specified signal is added earlier to the projector 500.

### Fourth Image Data Output Process

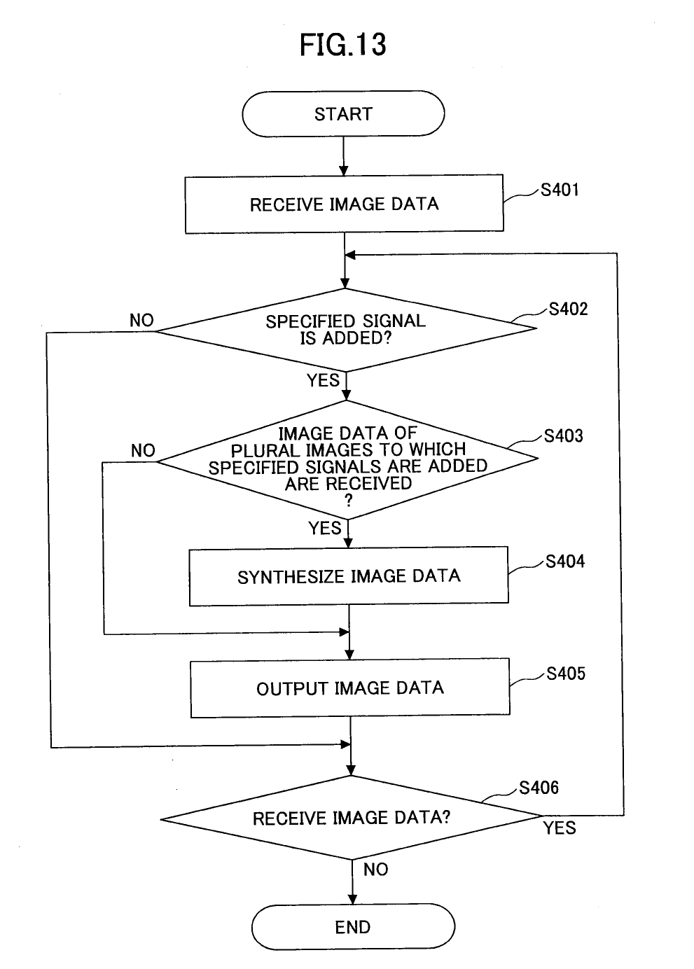

FIG. 13 is a flowchart illustrating an example of a fourth process of outputting image data according to the present embodiment. In the fourth image data output process, in the case where the image data to which specified signals are added are sent to the image processing apparatus 400 from plural devices out of the cloud 100, the PC terminal 200 and the tablet type terminal 300, synthesized image data are output.

When image data are sent to the information processing apparatus 400, the reception unit 410 receives the image data (step S401). Next, the specified signal interpretation unit 411 determines whether a specified signal is added to the image data (step S402). Moreover, the specified signal interpretation unit 411 acquires a number of images of image data to which specified signals are added (step S403).

In the case where the reception unit 410 receives image data of plural images to which specified signals are added (step S403: YES), the determination unit 430 determines image data synthesized by the synthesis unit 440 to be output, and the synthesis unit 440 combines the image data of the plural images to which the specified signals are added.

Meanwhile, when the number of images of the image data to which a specified signal is added is one (step S403: NO), the determination unit 430 determines the image data to which the specified signal is added to be output to the projector 500.

Next, the output unit 450 outputs the image data determined by the determination unit 430 to the projector 500 (step S405). Next, in the case where the reception unit 410 continues receiving image data (step S406: YES), the process from step S402 is executed again. In the case that the transmission of image data from the cloud 100, the PC terminal 200 or the tablet type terminal 300 has stopped and the reception unit 410 does not receive image data (step S406: NO), the fourth image data output process ends.

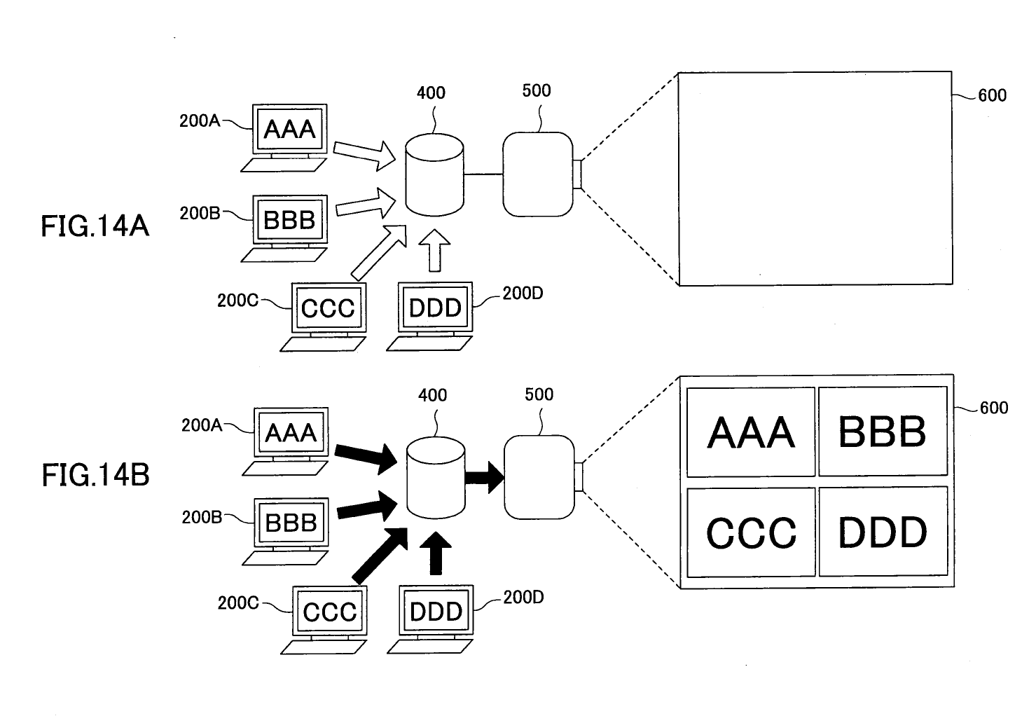

FIGS. 14A and 14B are diagrams illustrating examples of the image displayed by the fourth image data output process. In the examples shown in FIGS. 14A and 14B, PC terminals 200A to 200D are connected to the information processing apparatus 400, and from the respective PC terminals 200A to 200D, image data are sent to the information processing apparatus 400.

When a specified signal is not added to the image data sent to the information processing apparatus 400 from the PC terminals 200A to 200D, the image data are not output from the information processing apparatus 400 to the projector 500. Accordingly, in this case, as shown in FIG. 14A, the images displayed on the PC terminals 200A to 200D are not projected onto the screen 600.

In the case where specified signals are added to the image data sent from the PC terminals 200A to 200D to the information processing apparatus 400, the synthesis unit 440 synthesizes image data, and the synthesized image data are output to the projector 500. In the example shown in FIG. 14B, the image data from the PC terminals 200A to 200D are combined, and all the images displayed on the PC terminals 200A to 200D are projected onto the screen 600.

Meanwhile, the synthesis unit 440 may synthesize the image data so as to display the plural images equally. Moreover, a display size, a display position or the like of each of the plural images may be determined according to a priority of the PC terminals or an order of the addition of the specified signals.

### Fifth Image Data Output Process

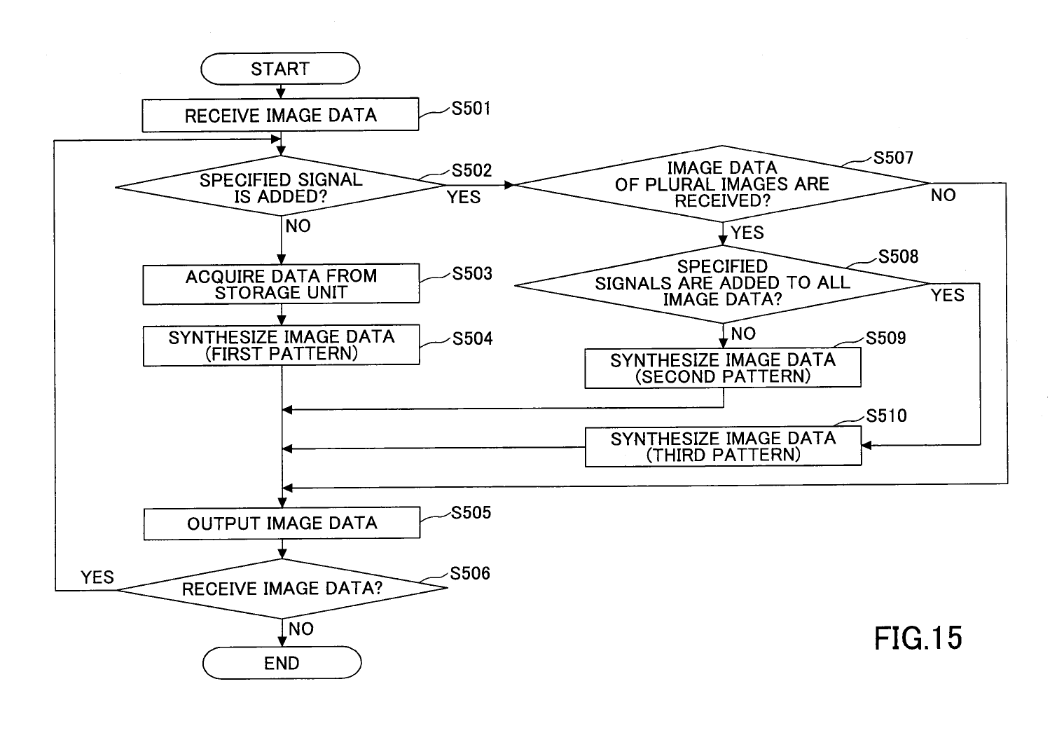

FIG. 15 is a flowchart illustrating an example of a fifth process of outputting image data according to the present embodiment. In the fifth image data output process, synthesized image data including image data to which a specified signal is not added are output from the information processing apparatus 400 to the projector 500.

When the image data are sent to the information processing apparatus 400, the reception unit 410 receives the image data (step S501). Next, the specified signal interpretation unit 411 determines whether a specified signal is added to the image data (step S502).

In the case where a specified signal is not added to the image data received by the reception unit 410 (step S502: NO), the determination unit 430 acquires image data stored in the storage unit 420 (step S503). Next, the synthesis unit 440 combines the image data acquired from the storage unit 420 and the image data received by the reception unit 410 (step S504), as a first pattern.

When a specified signal is added to the image data received by the reception unit 410 (step S502: YES), a number of images of the image data received by the reception unit 410 is acquired (step S507).

In the case where the reception unit 410 receives image data of plural images (step S507: YES), the specified signal interpretation unit 411 determines whether specified signals are added to all the image data (step S508).

When the specified signals are not added to all the image data (step S508: NO), the synthesis unit 440 synthesizes the image data so that an image of the image data to which the specified signal is added is displayed with a larger size and an image of the image data to which the specified signal is not added is displayed with a smaller size (step S509), as a second pattern.

In the case where the specified signals are added to all the image data (step S508: YES), the synthesis unit 440 combines the image data received by the reception unit 410 (step S510), as a third pattern.

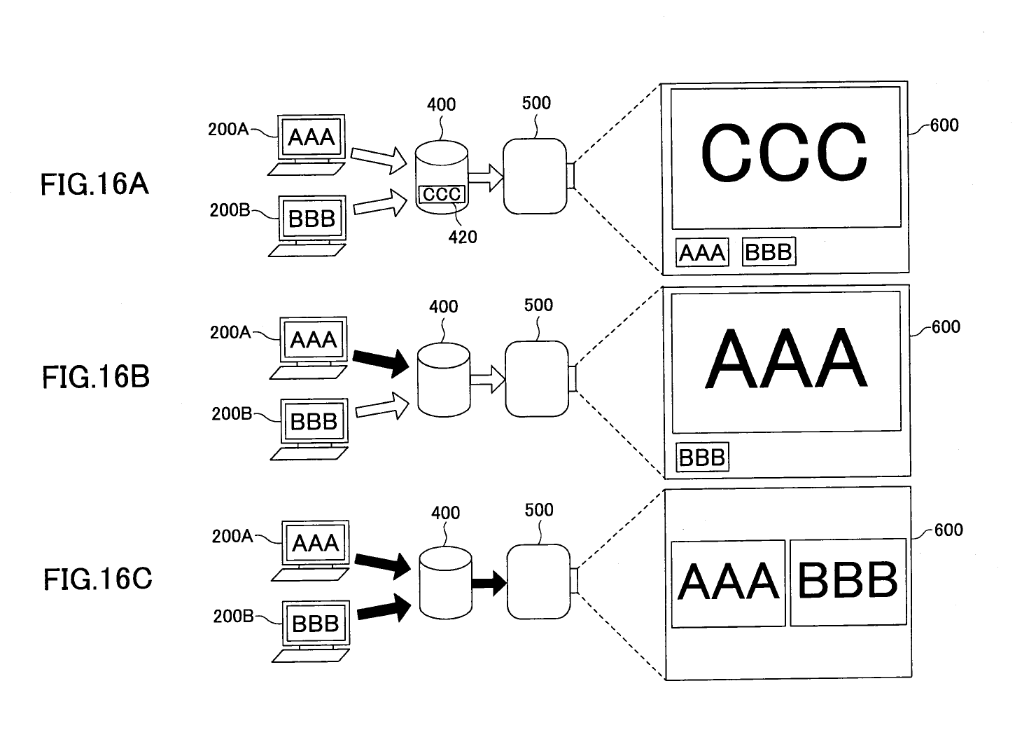

Next, the output unit 450 outputs the image data synthesized by the synthesis unit 440 to the projector 500 (step S505). Next, in the case where the reception unit 410 continues receiving image data (step S506: YES), the process from step S502 is executed again. In the case that the transmission of image data from the cloud 100, the PC terminal 200 or the tablet type terminal 300 has stopped and the reception unit 410 does not receive image data (step S506: NO), the fifth image data output process ends. FIGS. 16A to 16C are diagrams illustrating examples of an image displayed by the fifth image data output process. In the examples shown in FIGS. 16A to 16C, PC terminals 200A and 200B are connected to the information processing apparatus 400, and from the respective PC terminals 200A and 200B, image data are sent to the information processing apparatus 400.

In the case where image data to which a specified signal is not added are sent from the PC terminals 200A and 200B to the information processing apparatus 400, as shown in FIG. 16A, image data are synthesized by the synthesis unit 440 so that, for example, an image of the image data stored in the storage unit 420 is displayed with a larger size, and images of the image data sent from the PC terminals 200A and 200B are displayed with a smaller size (step S504), as the first pattern.

A user who gives a presentation, for example, may store an advertisement image of the user's company in the storage unit 420 of the information processing apparatus 400. The user can prepare a presentation document while looking at the images displayed on the PC terminals 200A and 200B which are displayed on the screen with a smaller size, in a state where an advertisement image is displayed with a larger size. When the preparation of the document or the like is completed, the user adds a specified signal to the image data, and an image of the document is displayed with a larger size in place of the advertisement image. Then, the user can start the presentation.

As shown in FIG. 16B, in the case where image data to which a specified signal is added are sent from the PC terminal 200A and image data to which a specified signal is not added are sent from the PC terminal 200B, image data are synthesized by the synthesis unit 440 so that an image of the image data from the PC terminal 200A is displayed with a larger size and an image of the image data from the PC terminal 200B is displayed with a smaller size (step S509), as the second pattern.

As shown in FIG. 16C, in the case where image data to which specified signals are added are sent from the PC terminals 200A and 200B, image data are synthesized by the synthesis unit 440 so that images of the image data from the PC terminals 200A and 200B are displayed with an equal size (step S510), as the third pattern.

Meanwhile, the synthesis unit 440 may combine the image data sent from the PC terminal 200 or the like and the image data stored in the storage unit 420 with a configuration different from those in the examples shown in FIGS. 16A to 16C.

As explained above, in the information processing apparatus according to the present embodiment, image data to be output to the projector 500 are determined in response to a presence or absence of the specified signal to be added to the received image data. For example, the addition of the specified signal to a document to be projected by the projector 500 can prevent the user, who uses the

PC terminal for giving a presentation, from leaking secret information by projecting an accidentally opened document by the projector 500.

### Second Embodiment

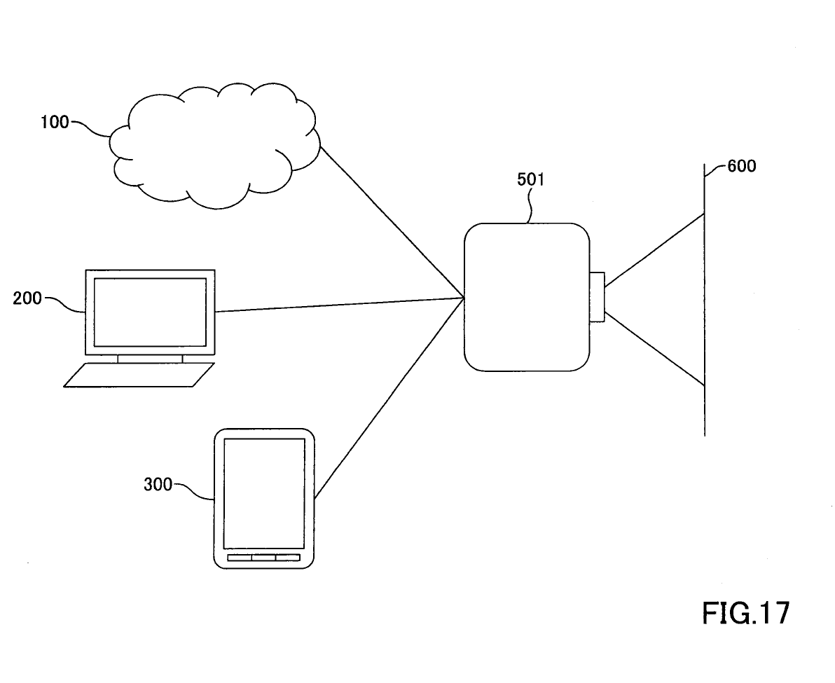

A projector may have the function with which the information processing apparatus 400 is provided, as stated above. FIG. 17 is a diagram illustrating an example of an entire configuration of an information processing system according to the second embodiment including a projector 501, which is provided with the function of the information processing apparatus 400.

In the configuration shown in FIG. 17, a cloud 100, a PC terminal 200 and a tablet type terminal 300 are connected to the projector 501, and an image of image data which is determined in the projector 501 according to a presence or absence of a specified signal is projected onto a screen 600.

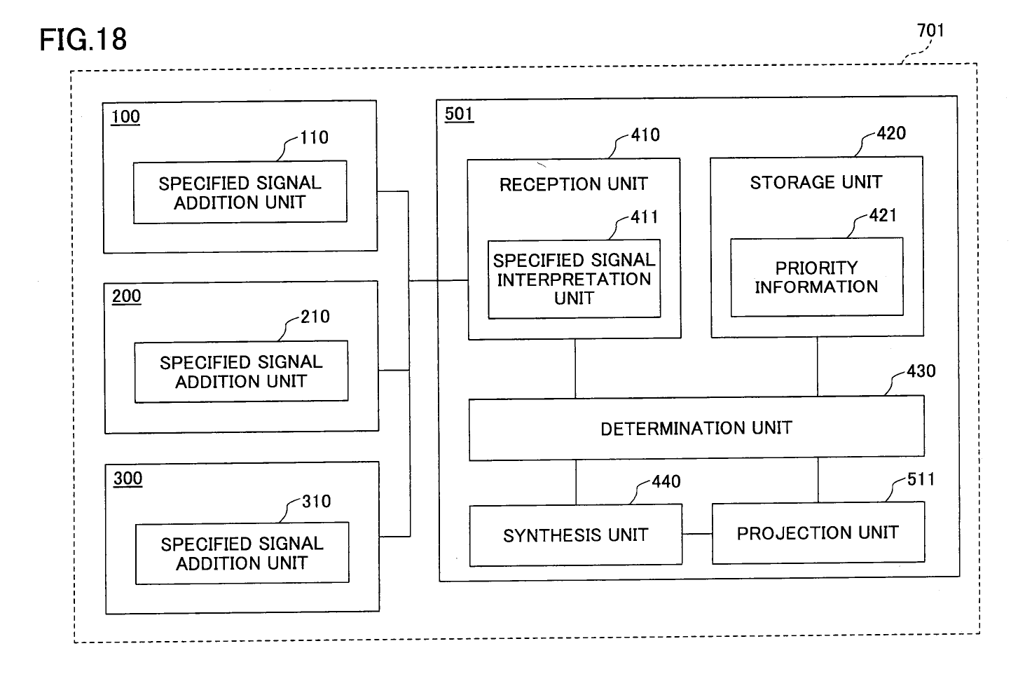

FIG. 18 is a diagram illustrating an example of the functional configuration according to the embodiment shown in FIG. 17. As shown in FIG. 18, an information processing system 701 includes an input device such as the cloud 100, the PC terminal 200, or the tablet type terminal 300 and the projector 501. The projector includes a reception unit 410, a storage unit 420, a determination unit 430 and a synthesis unit 440. The projector 501, in the same way as the above-described information processing apparatus 400, determines image data to be projected based on the presence or absence of the specified signal, and projects an image of the image data onto the screen 600 by a projection unit 511.

Even with the configuration exemplified by FIGS. 17 and 18, as in the first embodiment including the information processing apparatus 400, an accidentally opened document at the input device such as the PC terminal 200 is not projected, and a leak of the secret information is prevented.

Further, the present invention is not limited to these embodiments, but various variations and modifications may be made without departing from the scope of the present invention.

The present application is based on and claims the benefit of priority of Japanese Priority Applications No. 2013-085434 filed on Apr. 16, 2013 and No. 2014-043912 filed on Mar. 6, 2014 with the Japanese Patent Office, the entire contents of which are hereby incorporated by reference.

What is claimed is:

1. An information processing apparatus, comprising:
a reception unit that receives image data;
a determination unit that determines output image data based on a presence or absence of a specified signal added to the image data; and
an output unit that outputs the output image data.

2. The information processing apparatus as claimed in claim 1, wherein
the determination unit, when the reception unit receives image data of a plurality of images, to each of which the specified signal is added, determines the output image data out of the image data of the plurality of images based on an order of priority which is preliminarily set for respective transmission sources of the image data of the plurality of images.

3. The information processing apparatus as claimed in claim 1, wherein
the determination unit, when the reception unit receives image data of a plurality of images, to each of which the specified signal is added, determines the output image data out of the image data of the plurality of images based on an order of receiving the specified signals.

4. The information processing apparatus as claimed in claim 1, further comprising
a synthesis unit that combines image data to synthesize image data, wherein
the determination unit, when the reception unit receives image data of a plurality of images, to each of which the specified signal is added, determines the synthetized image data generated by the synthesis unit from the image data of the plurality of images to be the output image data.

5. The information processing apparatus as claimed in claim 4, further comprising
a storage unit that stores the image data, wherein
the determination unit, when the reception unit receives image data, to which the specified signal is not added, determines the synthesized image data generated by the synthesis unit from the image data stored in the storage unit and the image data to which the specified signal is not added to be the output image data.

6. An information processing method, comprising:
receiving image data;
determining output image data based on a presence or absence of a specified signal added to the image data; and
outputting the output image data.

7. An information processing system comprising an input device and an information processing apparatus, which are connected to each other, wherein
the input device includes a specified signal addition unit that adds a specified signal to image data, and
the information processing apparatus includes:
a reception unit that receives the image data from the input device;
a determination unit that determines output image data based on a presence or absence of the specified signal added to the image data; and
an output unit that outputs the output image data.
